(19) United States
(12) Patent Application Publication
(10) Pub. No.: US 2024/0300333 A1
(43) Pub. Date: Sep. 12, 2024

(54) UNDERBODY ELEMENT FOR A TRACTION BATTERY OF A MOTOR VEHICLE, MOTOR VEHICLE WITH AN UNDERBODY ELEMENT, AND METHOD FOR DETERMINATION OF AN INTRUSION INTO A TRACTION BATTERY OF A MOTOR VEHICLE

(71) Applicants: AUDI AG, Ingolstadt (DE); Dr. Ing. h.c. F. Porsche AG, Stuttgart (DE)

(72) Inventors: Julius RAUSCH, Heilbronn (DE); Oliver STOLL, Waldbrunn (DE); Ilija BRANDIC, Pleidersheim (DE); Markus GRUPP, Unterreichenbach (DE)

(73) Assignees: AUDI AG, Ingolstadt (DE); Dr. Ing. h.c. F. Porsche AG, Stuttgart (DE)

(21) Appl. No.: 18/262,691

(22) PCT Filed: Jan. 19, 2022
(86) PCT No.: PCT/EP2022/051054

§ 371 Date: Jul. 24, 2023

(30) Foreign Application Priority Data
Jan. 25, 2021 (DE) 10 2021 101 500.6

(51) Int. Cl. B60L 3/00; B60K 1/04

(52) U.S. Cl. CPC B60L 3/0046; B60K 1/04; B60K 2001/0438; B60L 2240/54

(57) ABSTRACT

A sensor device, a motor vehicle and a method of determining an intrusion into a traction battery with an underbody element of the motor vehicle, may include the underbody element including at least one sensor device including at least one electrically conductive sensor wire integrated into a laminar textile material. The sensor device is configured so that a voltage applied to the sensor wire is measurable to determine a deformation of the sensor wire in dependence on a measured change of the voltage.

### CROSS-REFERENCE TO RELATED APPLICATIONS

This application is a U.S. national stage of International Application No. PCT/EP2022/051054, filed on Jan. 19, 2022, which claims the priority benefit of German Application No. DE 10 2021 101 500.6 filed on Jan. 25, 2021. Both the International Application and the German Application are incorporated by reference herein in their entirety.

### BACKGROUND

### 1. Field

The described examples of an invention relate to an underbody element for a traction battery of a motor vehicle, which may include at least a sensor device, a motor vehicle with such an underbody element, as well as a method for determining an intrusion into a traction battery of a motor vehicle.

### 2. Description of the Related Art

Nowadays many motor vehicles are configured to be partly or fully electric, for instance as hybrid vehicle or as purely electrically operated motor vehicle. A drive battery or traction battery, which is required for this and which commonly comprises several battery cells, in the majority of cases in this connection is arranged in a bottom portion of the motor vehicle. This has the disadvantage that shocks hit the traction battery directly from the bottom, which may lead to damage to the traction battery. In order to limit or avoid damage by an intrusion from below, it is known to employ an underbody element for the traction battery, which for instance may be configured as underride protection, in order to protect the traction battery against a direct force effect. Therein the underbody element may be a lining on the underbody of the traction battery and/or of the motor vehicle, which shields the traction battery from environmental influences and/or mechanical influences.

However, also an underbody element does not keep all shocks away from the traction battery and in the case of heavy shocks from below, for instance in the event of the motor vehicle touching down when crossing a bollard, it may happen that the underbody element is pushed into the traction battery and hereby damage to the traction battery is caused. This means an intrusion into the traction battery may occur. For such damage to be able to be detected and subsequent damage to the motor vehicle and/or dangers for a driver of the motor vehicle to be minimized, a detection of these incidents is necessary, in order to draw conclusions as to whether battery cells of the traction battery have experienced an intrusion. This means that a sensing concept is required to be able to detect a physical intrusion or a deformation of the traction battery.

From the EP 1 168 463 A1 a fiber composite material with integrated piezoelectric sensor or actuator is known. Herein the electric supply lines for the actuator or sensor are configured in the form of electrically insulated, thin wires, which are led out perpendicularly to the laminate layers from the fiber composite material, wherein the fibers are not severed by leading out the supply lines, but rather are pushed apart.

### SUMMARY

In an example, detecting damage to a traction battery which originates from below the motor vehicle may be provided.

Examples of an invention may be described by way of the independent patent claims. Advantageous further developments of the examples may be disclosed in the dependent patent claims, the following description, as well as the figures.

In an example, an underbody element for a traction battery of a motor vehicle may include at least one sensor device. Underbody element here refers to a bottom lining, in particular an underride protection, which in an installation position in the motor vehicle according to the intended purpose may be arranged in the direction of a bottom side of the motor vehicle and/or the traction battery and provides the at least one protection effect against external influences. According to an example, the underbody element may include at least one sensor device, wherein the sensor device may include at least one electrically conductive sensor wire, which may be integrated into a laminar textile material, wherein the sensor device may be configured to measure a voltage applied to the sensor wire and to determine a deformation of the sensor wire in dependence on a measured change of the voltage.

In other words the at least one electrically conductive sensor wire may be integrated into a laminar textile material. For instance, the wire material may be applied to a laminar textile semifinished product. The textile material may herein serve as carrier structure, which may facilitate an attachment of the sensor wire to the underbody element. Thus, for example the textile material may be attached in a laminar way to the underbody element so that the sensor wire may be evenly distributed on the underbody element and cover a major part of the underbody element. The textile material may for instance be configured as fiber composite material, whereby an increase of the firmness may be achieved. A current at a predetermined voltage may flow through the sensor wire, which may for instance be configured to be made of a metal, wherein a deformation of the sensor wire may lead to a change of the voltage and thus in the case of a detected change the deformation of the underbody element and consequently an intrusion into a traction battery of the motor vehicle may be detected. By the example the advantage may arise that in a simplified way a deformation, in particular a deformation of the underbody element, may be detected, wherein from the deformation of the underbody element a damage of the traction battery may be concluded.

By the described examples, additional advantages may be derived.

An example envisages that the sensor wire may be integrated in meandering form into the laminar textile material. In other words, the sensor wire may extend in the form of loops across a predetermined width of the textile material. Hereby the advantage may arise that the sensor wire covers a large portion of the textile material whilst saving material of the sensor wire and thus an improved sensing of deformations may be provided.

An example may envisage that the sensor wire may be formed of a carbon fiber or a metal-coated plastic filament. In other words, the sensor wire may be configured as carbon fiber, which may be worked into the laminar textile material. The advantage of carbon may be a very good electric conductivity and at the same time an improved possibility of integrating the sensor wire into the textile material. Moreover, by the carbon fiber a structure of the underbody element may be reinforced. In particular carbon may be processed as fiber composite material. Alternatively, the sensor wire may be configured as a plastic filament, which may be coated with a metal. The advantage of a plastic filament may be that this is particularly easy to integrate into the textile material, which facilitates a manufacturing and saves costs. The conductivity of the sensor wire in this connection may be provided by the coating with metal. In a further alternative the sensor wire may be configured to be made from a metal, in particular copper, which may be integrated into the textile material at low cost.

A further example may envisage that the sensor wire may be configured to change an electrical resistance upon a deformation. This means that the change of the voltage and thus the deformation of the sensor wire may be determined by the sensor wire changing its electrical resistance. If the underbody element deforms, the length and/or the diameter of the sensor wire changes, which leads to a measurable change in resistance. In an example, the sensor wire therefore may be provided to be made of suitable materials, in particular carbon, which changes a length and thickness of the sensor wire upon deformation. Alternatively, the sensor wire upon an excessive deformation may also break, wherein here the change of the voltage may be determined, if no current flows through the sensor wire any more.

A further example may envisage that the sensor device may be configured to generate a warning signal, in case the measured change of the voltage exceeds a predetermined voltage threshold value. In other words, the sensor device may determine how large is the change of the voltage. If the change exceeds a predetermined voltage threshold value, a warning signal may be generated. The warning signal may be used to warn a driver of the motor vehicle. For example the warning signal may serve as control signal for a control lamp, which may indicate a damage of the traction battery to the driver of the motor vehicle. Also the sensor device may comprise an electronic system or an evaluation unit, respectively, which may measure and evaluate the voltage, wherein in dependence on the measured change of the voltage also several voltage threshold values may be provided, which may indicate the different severity degrees of intrusions into the traction battery of the motor vehicle. In particular, the change of the voltage may be dependent on the deformation of the sensor wire, whereby the warning signal may be provided in dependence on the change of the voltage. This example may have the advantage that a damage of the traction battery and/or a deformation of the sensor wire may be recognized not until a certain threshold as such and minor shocks that lead to no damage may be avoided as error detection.

An example may envisage that the laminar textile material with the sensor wire may be arranged on a surface of the underbody element in the direction of the motor vehicle when the underbody element is installed according to the intended purpose. In particular the laminar textile material may be glued to the surface of the underbody element. For gluing the textile material together with the surface of the underbody element the textile material or textile semifinished product may previously be injected with resin and thus be attached as thin plate to the surface. Hereby results a way of attachment of the sensor device to the underbody element.

A further example may envisage that the underbody element may include a foam inlay as bending-resistant intermediate layer between at least two cover layers, wherein the laminar textile material with the sensor wire may be arranged between the foam inlay and one of the two cover layers. In other words, a different setup of the underbody element may envisage that the textile material is arranged between one of the two cover layers and an intermediate layer, which may be configured as foam inlay. Thus, the textile material or textile semifinished product may be directly integrated into the manufacturing process of the underbody element. The cover layers may be configured from a fiber glass fabric, whereby an additional protective effect may be provided. By this example a further attachment form of the sensor device into the underbody element may be provided.

In a further example it may be envisaged that the underbody element may include a foam inlay as bending-resistant intermediate layer between at least two cover layers, wherein the laminar textile material with the sensor wire may be integrated into the foam inlay. In other words, the underbody element may be configured in a way similar to the afore-mentioned example, that is with two cover layers, which may include a foam inlay in between, wherein the textile material with the sensor wire may be foamed into the foam inlay. For example, in a production process, the textile material may be foamed in place in such a way that the textile material may be integrated into the bending-resistant intermediate layer. By this example a further attachment form of the sensor device into the underbody element may be provided.

In the afore-mentioned example, it may be envisaged that a respective end of the sensor wire may be connected to a plug unit, which may be integrated into the foam inlay, wherein the plug unit is capable of being coupled via an exposed opening through at least one of the cover layers and the intermediate layer by a plug into an evaluation unit of the sensor device. In other words, in case the textile material with the sensor wire may be integrated into the foam inlay, additionally a plug unit may be provided into the foam inlay, which for instance may also be foamed in place in a manufacturing process together with the textile material. The sensor wire in the textile material may be connected to this plug unit, for example directly or via a metal plate, which in particular may provide an improved manufacturing tolerance. The plug unit may then be exposed subsequently, for instance by drilling, in order to achieve an access to the plug unit. Subsequently, a plug may be employed to couple the plug unit and thus the sensor wire to an evaluation unit of the sensor device. Hereby, a cost-efficient, simplified, and reproducible contacting of the respective ends of the sensor wire may be provided to tap signals of the voltage and consequently to detect a deformation of the underbody element.

A further aspect of the described examples relate to a motor vehicle with an underbody element according to any one of the preceding described examples of the underbody element. The motor vehicle according to the examples may be designed as a motor car, in particular as passenger car or truck, or as passenger bus or motorcycle. In an example, the motor vehicle may be configured as electrically operated motor vehicle with at least one traction battery.

In an example of the motor vehicle, it may be envisaged that the motor vehicle may include a traction battery and the underbody element may include several chambers for arrangement of the battery cells of the traction battery, wherein the textile material with the sensor wire may be arranged in laminar form in the portions of the chambers on or into the underbody element. In other words, the underbody element may comprise recesses, in which battery cells of the traction battery may be arranged. In these chambers, which represent laminar portions in the underbody element, the textile material with the sensor wire may be arranged. Thus, sensor surfaces at the height of the battery cells may be rendered, wherein each chamber of the chambers thus may comprise a sensor wire of their own, whereby in the case of a deformation, it may be determined in an improved way, which chamber was deformed. By this example an advantage may be provided that a deformation and thus a damage of one of the battery cells may be localized in an improved way.

According to an example, a method for detecting an intrusion into a traction battery of a motor vehicle may be provided, with an underbody element according to any one of the preceding described examples of the underbody element. The method envisages that by the sensor device of the underbody element, which comprises at least one electrically conductive sensor wire that is integrated into a laminar textile material, a voltage applied to the sensor wire is measured and in dependence on a measured change of the voltage a deformation of the sensor wire and thus an intrusion into the traction battery is detected. In this connection the same advantages and variation possibilities result as in the case of the underbody element and/or in the case of the motor vehicle with the underbody element.

The described examples may also include the control device for the motor vehicle. The control device may include a data processing device or a processing device configured to perform a method according to the described examples. For this purpose, the processor device may include at least one microprocessor and/or at least one microcontroller and/or at least one FPGA (Field Programmable Gate Array) and/or at least one DSP (Digital Signal Processor). Moreover, the processor device may include program code, which may be configured to perform the described examples of the method when being executed by the processor device. The program code may be stored in a data memory of the processor device.

The described examples may also include further developments of the method, which may include features as they have already been described in connection with the further developments of the underbody element according to the described examples. For this reason the corresponding further developments of the method according to the described examples are here not described again.

The described examples may also include the combinations of the features of the described examples. The described examples may also include realizations, which each comprise a combination of the features of several of the described examples, as far as the examples have not been described as mutually exclusive.

### BRIEF DESCRIPTION OF DRAWINGS

These and other aspects and advantages will become more apparent and more readily appreciated from the following description of the examples, taken in conjunction with the accompanying drawings of which:

FIG. 1 is a schematically represented motor vehicle with an underbody element according to an example;

FIG. 2 is a schematically represented underbody element with a sensor device according to an example;

FIG. 3 is a schematically represented application location of a textile material with a sensor wire, according to a first example;

FIG. 4 is a schematically represented application location of a textile material with a sensor wire, according to a second example;

FIG. 5 is a schematically represented application location of a textile material with a sensor wire, according to a third example;

FIG. 6 is a schematically represented underbody element with an integrated sensor wire and an integrated plug unit.

### DESCRIPTION

The examples explained in the following are examples of the invention. In the examples the described components of the examples each represent individual features that are to be viewed independently of each other, which further develop the examples in each case also independently of each other. Therefore the disclosure should also include other combinations of the features of the examples than the those described. Moreover, the described examples may also be supplemented by further features of the already described features of the examples.

In the figures same reference signs in each case refer to functionally identical elements.

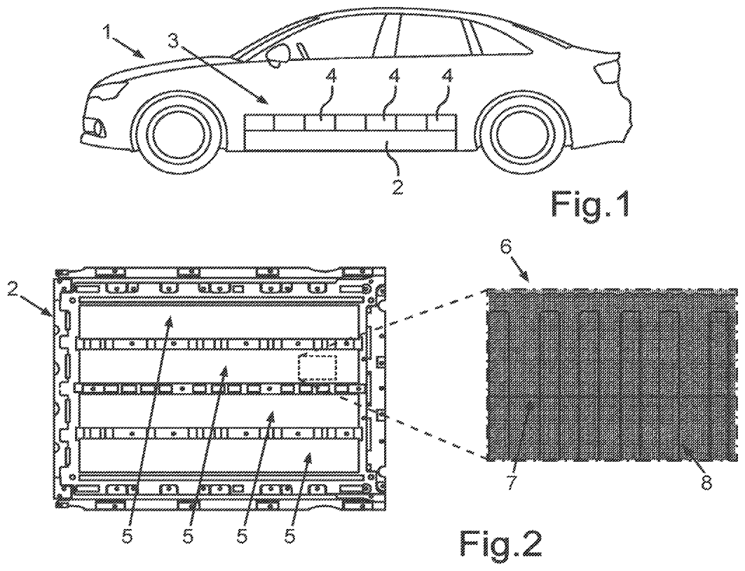

In FIG. 1 a schematized motor vehicle 1 is represented with an underbody element 2 according to an example. The motor vehicle 1 may for instance be a passenger car, which is electrically operated. For energy supply the motor vehicle 1 may comprise a traction battery 3 or drive battery, respectively, wherein the traction battery 3 may include several battery cells 4.

For protection of the traction battery 3 and the respective battery cells 4 against shocks from below the motor vehicle 1, the underbody element 2, which may be configured as underride protection, may be arranged below the attachment location of the traction battery 3. In an example, the underbody element 2 may be configured to protect the traction battery 3 against mechanical influences. Nevertheless, it may happen that due to a strong shock from below the motor vehicle 1, in the event of the motor vehicle touching down when crossing a bollard, an intrusion into the traction battery 3 may occur. In order to detect this intrusion and to warn a driver of the motor vehicle 1 against a damage to the traction battery 3, it may therefore be envisaged to provide a sensing concept for the traction battery 3.

In FIG. 2 the underbody element 2 of the motor vehicle 1 is schematically represented in a top view from the direction of the traction battery 3, wherein the traction battery 3 in this figure is not represented. The underbody element 2 may include several chambers 5, which are configured as laminar portions, wherein in the chambers 5 the battery cells 4 of the traction battery 3 may be arranged. In order to detect shocks to the traction battery 3 and the respective battery cells 4, a sensor device 6 may be provided, which for instance is arranged in a laminar way, in each of the chambers 5. In FIG. 2, a section of the sensor device 6 is shown, wherein the sensor device 6 may be arranged on an entire surface of the chambers 5. The sensor device 6 may be configured to detect a deformation of the underbody element 2 and thus an intrusion into the traction battery 3. The arrangement of the sensor device 6 in the respective chamber may have the advantage that a detection of a deformation of the respective chamber 5 may be facilitated and thus a localization, at which battery cell 4 a damage has occurred.

The sensor device 6 may include a laminar textile material 7, into which a sensor wire 8 may be integrated. The textile material 7, which may also be referred to as laminar textile semifinished product, may facilitate an attachment of the sensor wire 8 in the underbody element 2, in particular in the chambers 5. The sensor wire 8 may for example be formed from a carbon fiber, which may be particularly easy to integrate into the textile material 7 and may include breaking and expanding properties. Moreover, the sensor wire 8 may be worked into the textile material 7 in meandering form so that a good compromise between saving material and covering a surface may be provided for detection.

For detection of a deformation it may be envisaged that by the sensor wire 8 a current, in particular of a predetermined voltage, is measured by the sensor device 6, wherein in dependence on a change of the voltage a deformation of the sensor wire 8 may be detected. For this purpose the sensor wire 8 may be configured to change an electrical resistance upon deformation, for instance by changing a length and/or a diameter of the sensor wire during the deformation, which leads to a measurable change in resistance. If the sensor wire 8 is bent excessively and beyond a defined deflection, it may for instance be provided that a measured change of the voltage exceeds a predetermined voltage threshold value and a driver of the motor vehicle 1 may subsequently receive a warning signal, which is generated by the sensor device 6 in the case of exceeding the voltage threshold value. Thus, in a simplified way a deformation of the underbody element 2 and consequently an intrusion into the traction battery 3 or one of the battery cells 4 can be detected.

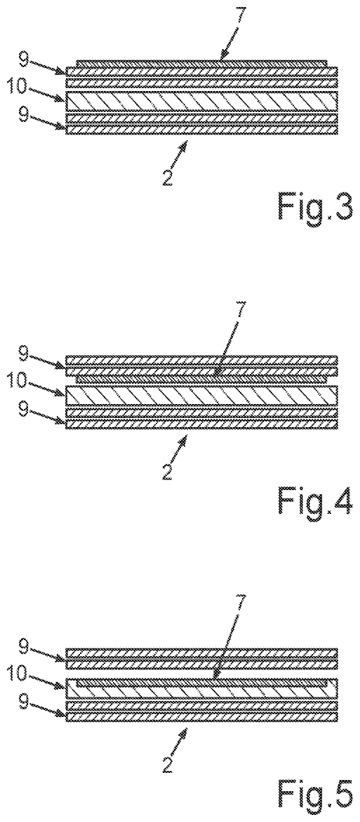

In FIGS. 3 to 5 examples of application locations for the sensing wire integrated in the textile material are represented. In FIG. 3 a first example is shown, in which the textile material is arranged with the sensor wire on a surface of the underbody element 2, wherein the surface is arranged in the direction of the motor vehicle. This means that on the inner surface of the underbody element 2 in the direction of the traction battery 3. In this connection the textile semifinished product (textile material 7) with the sensor wire 8 may subsequently be attached, for example glued, to the inner surface of the finished underbody element 2. For this purpose the textile material 7 in an upstream manufacturing step may for example be injected with resin in order to generate a thin plate therefrom, which can be glued to the surface of the underbody element 2. The underbody element 2 itself in this connection may be configured to comprise several layers, in particular two cover layers 9 and a foam inlay 10 as bending-resistant intermediate layer between the two cover layers 9.

In FIG. 4 a second example of application location for the textile material 7 with the sensor wire 8 in the underbody element 2 is shown. In this example the textile material 7 with the sensor wire 8 may for example be directly integrated into the underbody element 2, for instance directly integrated into the underbody element 2, for example by inserting the textile material 7 in a wet process between the foam inlay 10 and one of the cover layers 9. For example, the textile material 7 may be inserted between the foam inlay 10 and the top cover layer 9. The cover layer 9 may for example be given as glass layer or fiber glass core/fiber glass fabric and provide a stability of the underbody element 2.

In FIG. 5 a third example of an application location for the textile material 7 with the sensor wire 8 is represented. In this example the textile material 7 may be foamed in directly in a prefabricated foam inlay 10 of the underbody element 2. This means the laminar textile material 7 is located in the foam inlay 10, which is enclosed by the two cover layers 9.

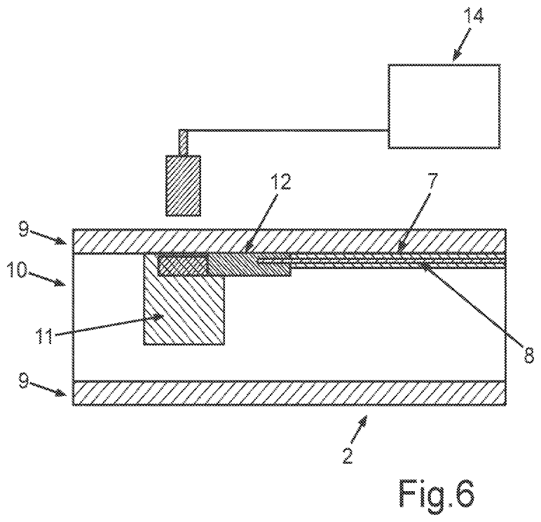

In FIG. 6 an underbody element 2 with a plug integration for the third example application location is shown, in which the textile material 7 is integrated with the sensor wire 8 into the foam inlay 10. In order to contact the sensor wire 8 and to tap a signal, in particular to measure the voltage applied to the sensor wire 8, in a manufacturing process additionally to the textile material 7 also a plug unit 11 may be foamed in in the foam inlay 10. For example, the sensor wire 8 may be connected to the plug unit 11, either directly or via a metal plate 12, wherein by the metal plate 12 a manufacturing process may be facilitated, in particular due to an easy connection of the metal plate 12 with the sensor wire 8. For example an end of the sensor wire 8 with the metal plate 12 may be fixed, in particular by local gluing on the metal plate 12, wherein the metal plate 12 may be electrically coupled to the plug unit 11.

In order to reach the plug unit 11 from outside, in the manufacturing process an opening through at least one of the cover layers 9 and the foam inlay 10 up to the plug unit 11 may be exposed, via which the plug unit 11 is capable of being coupled into an evaluation unit 14 of the sensor device 6. In other words, the access to the plug unit 11 may be cut out subsequently by an exact positioning of the plug unit 11, for example by drilling a hole through the cover layer 9 subsequently. A further plug unit, which is not shown here, may connect another end of the sensor wire 8 with a further plug leading to the evaluation unit 14. Thus, a cost-efficient, simplified, and reproducible contacting of the wire ends may be provided in order to be able to tap signals.

Overall, the examples show how via a resistance sensing in the underbody element 2, a sensing concept for a traction battery 3 may be provided by a detection of a deformation of the underbody element allowing for drawing conclusions of an intrusion into battery cells 4.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1-12. (canceled)

13. An underbody element for a traction battery of a motor vehicle, the underbody element comprising
at least one sensor device,
a sensor device of the at least one sensor device including,
at least one electrically conductive sensor wire integrated into a laminar textile material,
the sensor device configured to measure a voltage applied to the sensor wire and to determine a deformation of the sensor wire in dependence on a measured change of the voltage.

14. The underbody element according to claim 13, wherein the sensor wire is integrated in meandering form into the laminar textile material.

15. The underbody element according to claim 13, wherein the sensor wire is formed of a carbon fiber or a metal-coated plastic filament.

16. The underbody element according to claim 13, wherein the sensor wire is configured so that an electric resistance of the sensor wire is changeable in case of a deformation of the sensor wire.

17. The underbody element according to claim 13, wherein the sensor device is configured to generate a warning signal in case the measured change of the voltage is above a voltage threshold value.

18. The underbody element according to claim 13, wherein the laminar textile material with the sensor wire is arranged on a surface of the underbody element in a direction of the motor vehicle when the underbody element is installed on the motor vehicle.

19. The underbody element according to claim 13, wherein the underbody element comprises a foam inlay as a bending-resistant intermediate layer between at least two cover layers, wherein the laminar textile material with the sensor wire is arranged between the foam inlay and one cover layer of the at least two cover layers.

20. The underbody element according to claim 13, wherein the underbody element comprises a foam inlay as a bending-resistant intermediate layer between at least two cover layers, wherein the laminar textile material with the sensor wire is integrated into the foam inlay.

21. The underbody element according to claim 20, wherein a respective end of the sensor wire is connected to a plug unit that is integrated into the foam inlay, wherein the plug unit is capable of being coupled via an exposed opening through at least one cover layer of the two cover layers and the foam inlay by a plug into an evaluation unit of the sensor device.

22. A motor vehicle including an underbody element for a traction battery of the motor vehicle, the motor vehicle comprising:
at least one sensor device, a sensor device of the at least one sensor device including,
at least one electrically conductive sensor wire integrated into a laminar textile material,
the sensor device configured to measure a voltage applied to the sensor wire and to determine a deformation of the sensor wire in dependence on a measured change of the voltage.

23. The motor vehicle according to claim 22, wherein
the underbody element comprises chambers for arrangement of battery cells of the traction battery, and
the laminar textile material with the sensor wire is arranged in a laminar way in regions of the chambers on or in the underbody element.

24. The underbody element according to claim 22, wherein the sensor wire is integrated in meandering form into the laminar textile material.

25. The underbody element according to claim 22, wherein the sensor wire is formed of a carbon fiber or a metal-coated plastic filament.

26. The underbody element according to claim 22, wherein the sensor wire is configured so that an electric resistance of the sensor wire is changeable in case of a deformation of the sensor wire.

27. The underbody element according to claim 22, wherein the sensor device is configured to generate a warning signal in case the measured change of the voltage is above a voltage threshold value.

28. The underbody element according to claim 22, wherein the laminar textile material with the sensor wire is arranged on a surface of the underbody element in a direction of the motor vehicle when the underbody element is installed on the motor vehicle.

29. The underbody element according to claim 22, wherein the underbody element comprises a foam inlay as a bending-resistant intermediate layer between at least two cover layers, wherein the laminar textile material with the sensor wire is arranged between the foam inlay and one cover layer of the at least two cover layers.

30. The underbody element according to claim 22, wherein the underbody element comprises a foam inlay as a bending-resistant intermediate layer between at least two cover layers, wherein the laminar textile material with the sensor wire is integrated into the foam inlay.

31. The underbody element according to claim 20, wherein a respective end of the sensor wire is connected to a plug unit that is integrated into the foam inlay, wherein the plug unit is capable of being coupled via an exposed opening through at least one cover layer of the at least two cover layers and the foam inlay by a plug into an evaluation unit of the sensor device.

32. A method determining an intrusion into a traction battery of a motor vehicle including an underbody element for the traction battery, the method comprising:
installing a sensor device for the underbody element, the sensor device including at least one electrically conductive sensor wire is integrated into a laminar textile material,
measuring a voltage applied to the sensor wire, and
determining in dependence on a measured change of the voltage, a deformation of the sensor wire and thus an intrusion into the traction battery.
